(19) United States
(12) Patent Application Publication
(10) Pub. No.: US 2021/0349225 A1
(43) Pub. Date: Nov. 11, 2021

(54) Underwater device including an anti-adhesive device and related methods

(71) Applicant: SERCEL, Carquefou (FR)

(72) Inventor: Thibaut CAPPE DE BAILLON, CARQUEFOU (FR)

(21) Appl. No.: 16/867,274

(22) Filed: May 5, 2020

(51) Int. Cl. G01V 1/16; G01V 1/38

(52) U.S. Cl. CPC G01V 1/162; G01V 1/38

(57) ABSTRACT

An underwater device having an outer surface that presents at least one cavity into which microorganisms are subject to grow, wherein said at least one cavity is covered or at least partially filled with an anti-adhesive device whose thickness is superior to 1 millimeter, and corresponding method for preventing microorganisms' growth and method of use.

### TECHNICAL FIELD

Embodiments of the subject matter disclosed herein generally relate to underwater devices for which microorganisms' growth is prevented or limited and related methods.

### DISCUSSION OF THE BACKGROUND

It is sought more particularly here below in this document to describe problems existing in the field of marine seismic data acquisition for oil prospecting industry. The invention of course is not limited to this particular field of application but is of interest for any technique that has to cope with closely related or similar issues and problems.

Marine seismic data acquisition and processing generate a profile (image) of the geophysical structure (subsurface) under the seafloor.

While this profile does not provide an accurate location for oil and gas, it suggests, to those trained in the field, the presence or absence of oil and/or gas. Thus, providing a high-resolution image of the subsurface is an ongoing process for the exploration of natural resources, including, among others, oil and/or gas.

The operations of acquiring seismic data in a marine environment conventionally use seismic sensors, like hydrophones. The hydrophones are distributed along cables in order to form linear acoustic antennas, also referred to as “streamers” or “seismic streamers”.

During a marine seismic exploration, as illustrated in FIG. 1, a vessel 910 tows seismic sensors 912 (detectors) distributed along a cable 914. Cable 914 carrying seismic detectors 912 is called a streamer 916. A streamer may be up to 10 km long and may be formed from plural sections of few hundreds of meters each. Vessel 910 may tow plural streamers 916 at once. Towed streamer 912 may have a constant depth relative to the ocean surface 918 throughout its length, or have a variable depth profile.

Vessel 910 also tows a seismic source 920 configured to generate seismic waves, which penetrate the solid structure under the seafloor 922, and are at least partially reflected by interfaces 924 or 926 between layers having different seismic wave propagation speeds. Seismic detectors 912 detect the reflected waves. The time delay between firing the seismic source and detecting a related reflection provides information about the location (depth) of reflecting interfaces.

Seismic exploration campaigns may last long periods (e.g., several months). During these campaigns, the streamers preferably remain in the water (except, for example, in cases of extreme unfavorable weather conditions) because recovering/deploying the streamers is expensive and tedious. Thus, the streamers are immersed in sea water for several consecutive months, at a shallow depth (a few meters), and are generally dragged at low speed (less than or equal to 5 knots). In these circumstances, the streamers' outer surfaces are subject to fouling, particularly due to the proliferation of microorganisms or bio-fouling. One of the most common types of microorganisms attaching to streamers is barnacles which adhere permanently to a hard substrate either by growing their shells directly onto the substrate of by means of a stalk.

In time, bio-fouling results in substantial disadvantages such as:
generating hydrodynamic flow noise;
amalgams or incrustations forming on the streamer's outer surfaces, which are likely to disturb seismic measurements;
   increasing drag on the streamers and, consequently, increasing fuel consumption to tow them and potentially leading to mechanical damage or rupture of the streamer;
a strong, unpleasant stench developing within a few days when streamers covered with bio-fouling are recovered and exposed to air; and
streamer skin being pierced by certain types of bio-fouling, resulting in liquid intake inside the streamer.

It is known from document US2014041450A1, the entire content of which is incorporated in its entirety herein by reference, to address a bio-fouling problem by applying a protection skin with antifouling properties to surround a streamer section length.

However, applying such a protection skin to a streamer section length is a complex process that imply to use a dedicated packing machine to make the streamer pass through a skin mounting area where the protection skin is wrapped around the streamer section.

According to document US2014041450A1 the mounting occurs when the streamer is moved to be deployed in the water. The mounting of the protection skin cannot be operated when the streamer is already deployed in the water.

Furthermore, according to document US2014041450A1, the protection skin applied with the packing machine to wrap a section of the streamer has to be applied on a long distance, although only some local zones of the streamer section may be sensitive to microorganisms' growth.

Document US2014041450A1 also proposes that, after a certain length of time the streamer has been submerged and when the streamer is recovered from the water, the protection skin be separated from the streamer, so that in the same time, any fouling deposited thereon is removed. However, such separation process is also complex and imply the use of dedicated apparatus such as a winch to roll back the skin.

Moreover, such a protection skin wrapped onto a streamer section is sensitive to deterioration. In particular, the skin may be damaged by equipment associated with the streamer or external obstacles that may cause cuts through the protection skin.

There is thus a need to provide a new underwater device and related method, that enable to overcome at least part of the drawbacks of the known acquisition device.

### SUMMARY

According to an embodiment, there is an underwater device having an outer surface that presents at least one cavity into which microorganisms are subject to grow, wherein said at least one cavity is covered or at least partially filled with an anti-adhesive device whose thickness is superior to 1 millimeter.

According to a particular aspect, said anti-adhesive device is elastically deformable.

According to another particular aspect, said anti-adhesive device is removable.

According to another particular aspect, said anti-adhesive applies on a local part of the outer surface of the underwater device that presents said at least one cavity.

According to another particular aspect, said anti-adhesive device includes an anti-adhesive material from a group including a super-hydrophobic material, a silicon material, and a fluorinated polymer or is covered with an antifouling paint.

According to another particular aspect, said anti-adhesive device includes an annular device adapted to surround a part of the outer surface of the underwater device that presents the at least one cavity.

According to another particular aspect, the anti-adhesive device includes:
a band that is adapted to extend around a part of the outer surface of the underwater device that presents the at least one cavity,
a closing system enabling to close the band around said part of the outer surface of the underwater device to cover the at least one cavity, the closing system being desactivable to open said band to access said at least one cavity.

According to another particular aspect, the at least one cavity includes an annular groove.

According to another particular aspect, the at least one cavity includes a separation zone defined between a part of the underwater device and an element that is over molded on said part of the underwater device, and the removable anti-adhesive device includes a bracelet that covers said separation zone.

According to another particular aspect, said element that is over molded on said part of the underwater device, is a clamping area element on which an apparatus is adapted to be clamped.

According to another particular aspect, the at least one cavity includes a separation zone defined between outer surfaces of two parts of the underwater device connected one to the other, and the removable anti-adhesive device covers the separation zone by applying on said outer surfaces of the connected two parts of the underwater device.

According to another particular aspect, said at least one cavity includes a space between a first part of the underwater device and a connecting bracket that connects said first part to a second part of the underwater.

According to another particular aspect, the underwater device includes a seismic streamer.

According to another particular aspect, the underwater device includes a marine equipment coupled to a seismic streamer.

According to another particular aspect, said anti-adhesive device includes at least one of:
a bracelet;
a muff; and
a plug.

According to another embodiment, it is proposed a method for preventing microorganisms' growth in at least one cavity of an outer surface of an underwater device, said method comprising:
mounting an anti-adhesive device on the outer surface of the underwater device for covering or at least partially filling said at least one cavity with said anti-adhesive device, said anti-adhesive device having a thickness that is superior to 1 millimeter;
before or after the mounting step, deploying the underwater device in water;
recovering the underwater device from the water.

According to a particular aspect, the anti-adhesive device is mounted on a local part of the outer surface of the underwater device that presents said at least one cavity.

According to a particular aspect, said method comprises:
removing the anti-adhesive device to clean and/or to access said at least one cavity,
reuse said anti-adhesive device for covering again or at least partially filling again said at least one cavity with said anti-adhesive device.

According to a particular aspect, said anti-adhesive device includes a band and the mounting step includes closing the band around a part of the underwater device, with a closure system.

According to a particular aspect, the anti-adhesive device has an initial closed annular form, and the mounting step includes putting on the anti-adhesive device onto the outer surface of the underwater device.

According to another embodiment, it is proposed a method of use of an annular device having a thickness of more than 1 millimeter and comprising anti-adhesive material at least on its exterior surface for preventing microorganisms' growth on an underwater device presenting at least one cavity wherein said anti-adhesive device can be mounted.

### LIST OF FIGURES

The invention is described in more detail below by way of the figures that show embodiments of the invention.

FIG. 1 is a schematic diagram of a marine seismic survey system;

FIG. 2 is a schematic cross section view of a cable part of a streamer provided with a clamping area element that is over molded on a portion of said cable part, with barnacles growing in cavities defined between extremities of the clamping area element and the external surface of the cable part;

FIG. 2A is a schematic cross section view of the cable part and the clamping area element of FIG. 2, with anti-adhesive devices that cover the extremities of the clamping area element according to an embodiment;

FIG. 3 is a schematic cross section view of two portions of a cable of a streamer connected one to the other with a mounting bracket, FIG. 3 also schematically showing apart an anti-adhesive device adapted to surround the mounting bracket, according to an embodiment;

FIG. 4 is a schematic cross section view of two portions of a cable of a streamer connected one to the other via a connecting mechanism that includes a locking ring, FIG. 4 also schematically showing apart, in cross section, an anti-adhesive device in the form of a muff adapted to surround the connecting mechanism and an anti-adhesive device in the form of a plug adapted to fill a hole in the connecting mechanism, according to an embodiment;

FIG. 5 is a schematic cross section view of two portions of a cable of a streamer connected one to the other via a holding device that has an annular groove, FIG. 5 also schematically showing apart an anti-adhesive device surrounding and filling the groove, according to an embodiment;

FIG. 6 is a schematic cross section view of a cable part of a streamer around which a weight is mounted, FIG. 6 also schematically showing an anti-adhesive device surrounding said weight, according to an embodiment;

FIG. 7 is a diagram showing steps of a method according to an embodiment.

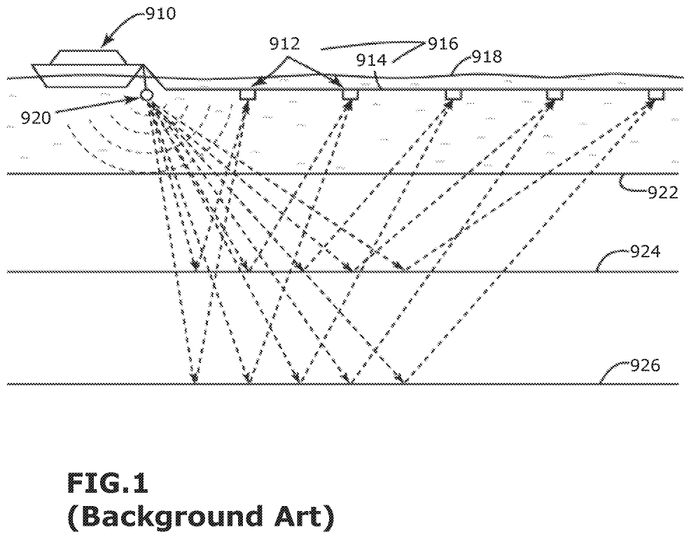

### DESCRIPTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

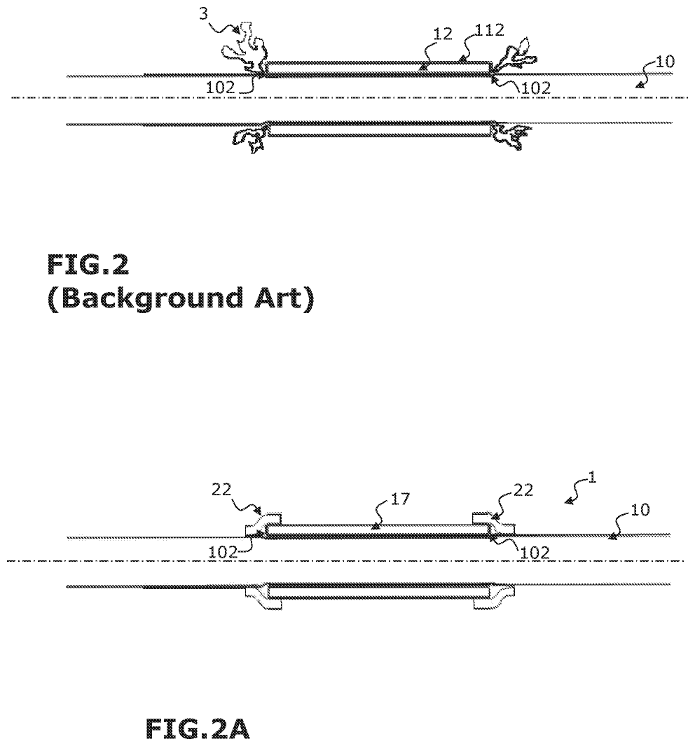

A micro-organic growth problem is illustrated at FIG. 2 for an underwater device that has an outer surface that presents cavities 102 into which microorganisms such as barnacles 3 are subject to grow. The term «cavity» has to be understood in a broad meaning, including «hole» and any part defining an irregularity of the surface wherein microorganisms are subject to grow.

In the example of FIG. 2, the underwater device comprises a cable part 10 and a clamping area element 12 over molded on a part of the cable part 10. Note that, usually, before over molding the clamping area element, a part of the external skin of the cable part is removed in a zone where the clamping area element is intended to be over molded. It can be observed that barnacles 3 are subject to grow into cavities that appear between the extremities of the clamping area element 15 and the external surface of the cable part 10.

In the following embodiments, it is proposed embodiments of underwater devices that have an outer surface that presents one or more cavities into which microorganisms are subject to grow. Note that when the following description makes reference to one cavity the description may also apply to more cavities.

To prevent growth of microorganisms in a cavity and/or to enable easy cleaning of the corresponding area where microorganisms may grow, the cavity is covered or at least partially filled with anti-adhesive device. According to a particular aspect, the anti-adhesive device is removable from said outer surface of the underwater device 1.

### Underwater Device

According to embodiments, the underwater device 1 is a part of a seismic streamer (or streamer). FIGS. 2A to 6 illustrate various parts of a streamer whose outer surface presents one or more cavities to be protected against microorganisms' growth.

In the embodiment of FIG. 2A, the underwater device includes a cable part 10 of a streamer that is provided with a clamping area element 17, on which an apparatus is intended to be clamped. In particular the clamping area element 17 is over molded on the cable part 10. The apparatus intended to be clamped can be a retriever system. A retriever system usually comprises a hollow body that includes a big bag and a bottle of gas for blowing the bag when predetermined excessive depth is reached by the retriever so that the big bag exits the hollow body.

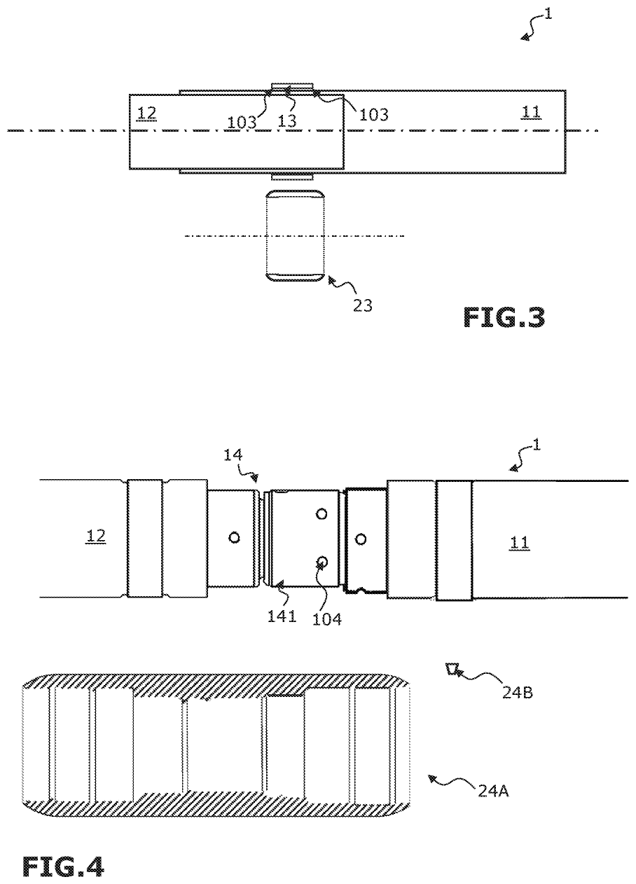

In the embodiment of FIG. 3, the underwater device includes an assembly of two parts 11, 12 of a cable of a seismic streamer that are connected one another using a mounting bracket 13.

In the embodiment of FIG. 4, the underwater device includes an assembly of two parts 11, 12 of a cable of a seismic streamer that are connected one another using a connecting mechanism 14 that includes a locking ring 141 that has to be moved to enable an operator to access to the connecting elements of the connecting mechanism. The protecting ring has one or more holes in which a specific tool can be inserted to move the locking ring in a position enabling to inactivate the connecting mechanism 14 and thus separate the two cable parts 11,12.

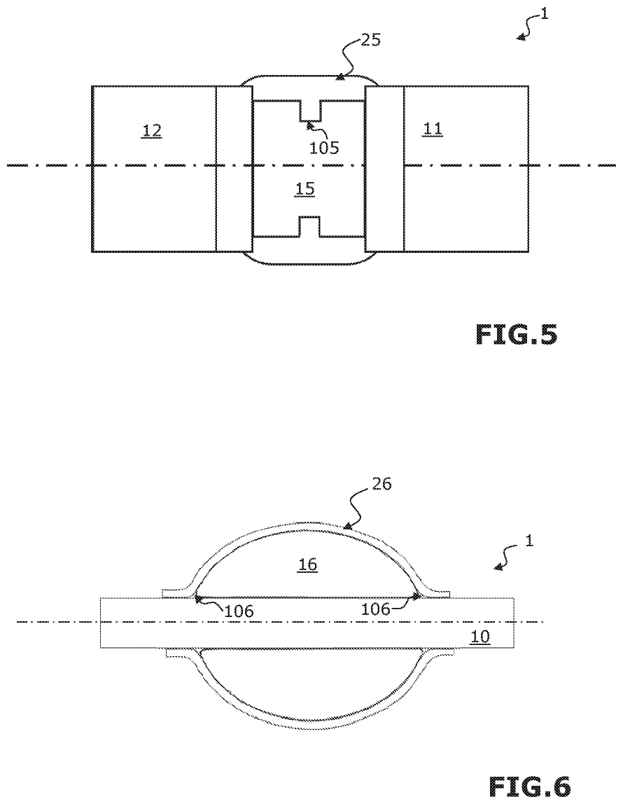

In the embodiment of FIG. 5, the underwater device includes an assembly of two cable parts 11, 12 of a seismic streamer that are connected to a holding element 15 that present an annular groove 105. The annular groove enables a dedicated apparatus, for instance located on board the vessel that is intended to tow the streamer, to cooperate with the holding element to grab the streamer at the holding element location, for instance to proceed to the deployment of the streamer.

In the embodiment of FIG. 6, the underwater device includes a cable part 10 of a streamer that is provided with a surrounding weight 16 fixed on the external surface of the cable part 10. The weight 16 has for instance an oval form and has an axial passage through to be mounted around the cable part. The weight 16 can be made in two parts that are fixed one to the other around the cable part, the cable part being sandwiched between the two parts of the weight to maintain the position of the weight along the cable part.

According to other embodiments, the underwater device can be a marine equipment, such as a retriever system or a navigation control device also referred to as a “bird”.

A bird is used to control the position of a streamer, in particular to control the depth as well as the lateral position. Birds are installed at regular intervals (every 300 meters for example) along a seismic streamer. Examples of birds are disclosed in U.S. Pat. No. 9,475,553, the entire content of which is incorporated herein by reference.

### Anti-Adhesive Device

To prevent or limit microorganism from growing into a cavity of the underwater device, the cavity is covered or at least partially filled with an anti-adhesive device. The anti-adhesive device is elastically deformable. The anti-adhesive device can be deformed (compressed or stretched) to fit (adjust) the shape of the part of the of the underwater device to cover or at least partially fill, while recovering its original shape when removed. Use of an elastic anti-adhesive device thus enable to remove it to access and or clean the cavity and then to reposition it, without fitting issue.

According to a preferred embodiment, the anti-adhesive device 2 is in silicone.

The anti-adhesive device has a thickness of more than 1 millimeter, preferably at least equal to 2 or 3 millimeters. In particular, the anti-adhesive device has a zone of greater thickness that is at least equal to 1 millimeter, preferably at least equal to 2 or 3 millimeters. The thickness of the anti-adhesive device make it differ from a film or skin that has by definition a small thickness, in particular inferior to 1 millimeter.

According to a particular embodiment, the anti-adhesive device is an annular device, openable or not, whose thickness is variable along a direction parallel to the axis of the through passage of the annular anti-adhesive device, said axis also corresponding to the axis of the part of the underwater device that is surrounded by the annular anti-adhesive device.

According to particular embodiments, the anti-adhesive device is acoustically transparent. The anti-adhesive device may be covered with an antifouling paint.

The shape of the anti-adhesive device can be configured so that the resulting underwater device presents hydrodynamic properties that limit flow turbulence at conventional acquisition speeds, thus avoiding downstream barnacles installation through re-circulating, and thereby decreasing hydrodynamic noise.

### Embodiments of Anti-Adhesive Device Used for Surrounding

When the anti-adhesive device is configured to surround a part of the underwater device, the anti-adhesive device may take the form of an elastic band or strap that can be closed around said part of the underwater device or of an elastic muff or elastic ring that can be put on or slip on (or threaded on) said part.

The anti-adhesive device can thus present an annular shape surrounding a part of the underwater device.

The annular shape of the anti-adhesive device can be the original shape of the anti-adhesive device in case the anti-adhesive device is a bracelet or a muff. The anti-adhesive device 2 can be configured to have an internal diameter that is, before mounting, inferior to the external diameter of the part of the underwater device that presents the at least one cavity so that the anti-adhesive device 2 correctly fits the shape of the part of the underwater device around which it is applied, and to ensure that the anti-adhesive device is kept in place.

The annular shape of the anti-adhesive device may not be the initial shape of the anti-adhesive device, but a shape obtained, in case the anti-adhesive device is a band or strap, when surrounding the part of the underwater device. In that case a closure system is used to close the band or strap around the part of the underwater device, preferably on itself.

For instance, the closure system provided on the anti-adhesive device can include magnets or pressure buttons or male/female shapes adapted to interlock one with the other.

Preferably the closure system can be opened to easily remove the anti-adhesive device.

According to a preferred embodiment, the anti-adhesive device has a dimension, taken along the surrounding axe, that is in the range 5 mm and 120 mm. The anti-adhesive device is thus intended to be used to cover a local area of the underwater device, contrary to a skin according to document US2014041450A1 that is applied on a large length of the streamer.

In the embodiment of FIG. 2, the anti-adhesive device includes an annular device 22, such as a bracelet, ring or muff, positioned at each extremity of the clamping area element 15 to cover a cavity 102 corresponding to the space formed by a separation zone defined between a part of the cable part 10 and the clamping area element 15 over molded on said part of the cable part 10.

According to a particular aspect, the internal diameter of the annular device 22 is inferior to the external diameter of the part of the cable part 10 on which the annular device is intended to apply.

In the embodiment of FIG. 3, the anti-adhesive device includes an annular device 23, such as a muff or cylinder, with a width adapted to cover the connecting bracket 13 that maintains connected the two cable parts 11,12. Cable part 11 overlaps a part of cable part 12. The annular device 23 is adapted to apply on the external surface of the connecting bracket 13 and on the external surface of cable part 11 to cover the cavities 103 corresponding to the spaces formed by a separation zone defined between each extremity of the connecting bracket 13 and the cable part 11.

In the embodiment of FIG. 4, the anti-adhesive device can also include an annular device 24A, such as a muff, similar to the annular device 23 of FIG. 3, but adapted to cover cavities of the connecting mechanism 14.

In the embodiment of FIG. 5, the anti-adhesive device includes an annular device 25 that has an internal shape adapted to fit the shape of the holding element 15 that extends between cable part 11, 12. In particular, the annular device 25 fills a cavity formed by the groove 105.

In the embodiment of FIG. 6, the anti-adhesive device includes an annular device 26, such as a mantle, that surrounds and fits the weight 16, in particular to cover each extremity of the weight, and thus to cover corresponding cavities 106 formed by a separation zone defined between a part of the cable part 10 and each extremity of the weight 16.

According to particular aspect, the annular device can be rolled up to easily clean and/or access the zone protected by the annular device, while remaining mounted on said the underwater device.

According to particular embodiments, the anti-adhesive device includes a bracelet that has the following ranges of dimensions:

| | | |
|---|---|---|
| Diameter (internal or external) | 40 to 80 | mm |
| Thickness | 5 to 40 | mm |
| Length | 5 to 120 | mm |

According to particular embodiments, the anti-adhesive device includes a muff that has the following ranges of dimensions:

| | | |
|---|---|---|
| Diameter (int or ext) | 40 to 80 | mm |
| Thickness | 1 to 10 | mm |
| Length | 50 to 250 | mm |

It is clear that the distinction between “bracelet” and “muff” simply intends to illustrate the element which is to be placed around a cylindrical part of an underwater equipment. The invention relates to anti-adhesive elements of any shape wherein the length is less than 100 times the thickness, with the thickness superior to 1 mm, preferably more than 5 mm.

The anti-adhesive device differs from a film or skin that is considered as a thin layer of material, a film or skin having one dimension which is very small compared to the others.

### Embodiments of Anti-Adhesive Device Used for Plugging

The anti-adhesive device can also include a plugging device used to fill partially or fully a cavity of an outer surface of the underwater device.

As illustrated at FIG. 4, the anti-adhesive device can include a plug (or insert) 24B adapted to fill a cavity corresponding to the hole 104.

Hole 104 can be a hole that receives a screw or a hole inside which a specific tool is intended to be introduced, for instance to unscrew the locking ring 141 of the connecting mechanism 14 used to connect the two cable parts 11, 12.

### Example of Method

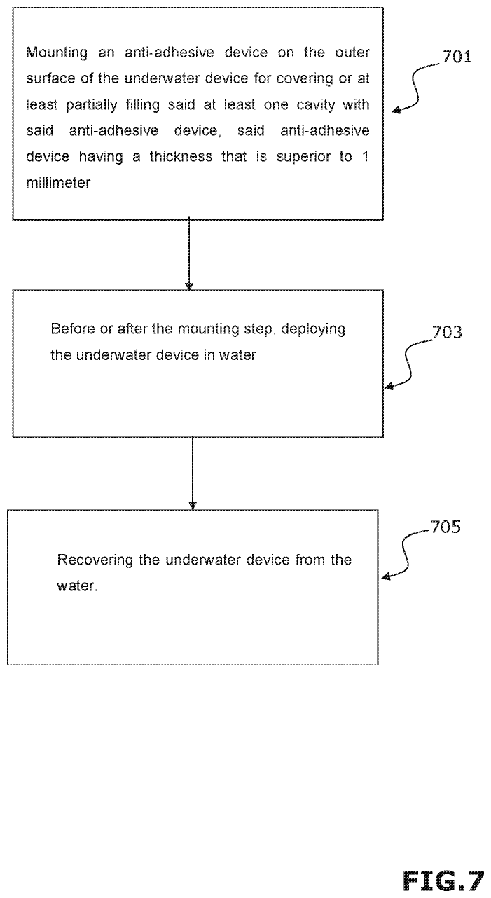

With reference to FIG. 7, it is proposed a method for preventing microorganisms' growth in at least one cavity of an outer surface of an underwater device.

At step 701 said method comprises mounting an anti-adhesive device on the outer surface of the underwater device 1 for covering or at least partially filling said at least one cavity with said anti-adhesive device. said anti-adhesive device has a thickness that is superior to 1 millimeter and can have features has detailed above.

At step 703, the underwater device 1 is deployed in water. In particular when using anti-adhesive device that present an initial form as a band or strap or plug, the anti-adhesive device easily be mounted onto the underwater device even said underwater device is already deployed.

When the underwater device is a streamer, the steps of mounting and deploying can be followed by the recording of seismic survey data using seismic receivers inside the streamer.

Then at step 705, for instance after a survey, the underwater device 1 can be recovered from water. Then each anti-adhesive device can be removed or locally rolled up to be cleaned and or to access to corresponding cavity. The anti-adhesive device can be easily repositioned at the same place to cover again or at least partially fill the corresponding cavity.

The thickness of the anti-adhesive device, that is superior to 1 mm, and preferably superior to 2 or 3 mm, limits the risk of deterioration of the anti-adhesive device, contrary to the use of a skin. The elasticity of the anti-adhesive device enables to fit the part of the underwater device to be covered or at least partially filled while assuring that the position of the anti-adhesive device is maintained on said part of the underwater device.

Furthermore, an anti-adhesive device can be easily mounted on the underwater device even after deployment in the water, in particular when the anti-adhesive device has an initial form of a band or strap intended to be closed around a part of the underwater device or when the anti-adhesive device is a plug.

The anti-adhesive device is locally applied on the underwater device, contrary to a skin according to document US2014041450A1 that is applied on the entire length of the streamer.

In particular, when the underwater device is a seismic streamer, the streamer presents portions that are free of said anti-adhesive device and cumulated length of these portions is superior to the length of a portion or portions covered by the anti-adhesive device.

Depending of the type of cavity to protect against microorganisms, the anti-adhesive device can be applied permanently on the outer surface that presents the cavity.

It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. Underwater device having an outer surface that presents at least one cavity into which microorganisms are subject to grow,
wherein said at least one cavity is covered or at least partially filled with an anti-adhesive device whose thickness is superior to 1 millimeter.

2. Underwater device according to claim 1, wherein said anti-adhesive device is elastically deformable.

3. Underwater device according to claim 1, wherein said anti-adhesive device is removable.

4. Underwater device according to claim 1, wherein said anti-adhesive applies on a local part of the outer surface of the underwater device that presents said at least one cavity.

5. Underwater device according to claim 1, wherein said anti-adhesive device includes an anti-adhesive material from a group including a super-hydrophobic material, a silicon material, and a fluorinated polymer or is covered with an antifouling paint.

6. Underwater device according to claim 1, wherein said anti-adhesive device includes an annular device adapted to surround a part of the outer surface of the underwater device that presents the at least one cavity.

7. Underwater device according to claim 1, wherein the anti-adhesive device includes:
a band that is adapted to extend around a part of the outer surface of the underwater device that presents the at least one cavity,
a closing system enabling to close the band around said part of the outer surface of the underwater device to cover the at least one cavity, the closing system being able to be deactivated to open said band to access said at least one cavity.

8. Underwater device according to claim 1, wherein the at least one cavity includes an annular groove.

9. Underwater device according to claim 1, wherein the at least one cavity includes a separation zone defined between a part of the underwater device and an element that is over molded on said part of the underwater device, and the removable anti-adhesive device includes a bracelet that covers said separation zone.

10. Underwater device according to claim 9, wherein said element that is over molded on said part of the underwater device, is a clamping area element on which an apparatus is adapted to be clamped.

11. Underwater device according to claim 1, wherein the at least one cavity includes a separation zone defined between outer surfaces of two parts of the underwater device connected one to the other, and
wherein the removable anti-adhesive device covers the separation zone by applying on said outer surfaces of the connected two parts of the underwater device.

12. Underwater device according to claim 1, wherein said at least one cavity includes a space between a first part of the underwater device and a connecting bracket that connects said first part to a second part of the underwater.

13. Underwater device according to claim 1, wherein the underwater device includes a seismic streamer.

14. Underwater device according to claim 1, wherein the underwater device includes a marine equipment coupled to a seismic streamer.

15. Method for preventing microorganisms' growth in at least one cavity of an outer surface of an underwater device, said method comprising:
mounting an anti-adhesive device on the outer surface of the underwater device for covering or at least partially filling said at least one cavity with said anti-adhesive device, said anti-adhesive device having a thickness that is superior to 1 millimeter;
before or after the mounting step, deploying the underwater device in water;
recovering the underwater device from the water.

16. The method of claim 15, wherein the anti-adhesive device is mounted on a local part of the outer surface of the underwater device that presents said at least one cavity.

17. The method of claim 15, wherein said method comprises:
removing the anti-adhesive device to clean and/or to access said at least one cavity,
reuse said anti-adhesive device for covering again or at least partially filling again said at least one cavity with said anti-adhesive device.

18. The method of claim 15, wherein said anti-adhesive device includes a band and the mounting step includes closing the band around a part of the underwater device, with a closure system.

19. The method of claim 15, wherein the anti-adhesive device has an initial closed annular form, and the mounting step includes putting on the anti-adhesive device onto the outer surface of the underwater device.

20. Method of use of an annular device having a thickness of more than 1 millimeter and comprising anti-adhesive material at least on its exterior surface for preventing microorganisms' growth on an underwater device presenting at least one cavity wherein said anti-adhesive device can be mounted.
